(19) United States
(12) Patent Application Publication
(10) Pub. No.: US 2026/0121068 A1
(43) Pub. Date: Apr. 30, 2026

(54) ELECTROCHEMICAL DEVICE AND ELECTRONIC DEVICE

(71) Applicant: NINGDE AMPEREX TECHNOLOGY LIMITED, Ningde (CN)

(72) Inventor: Lele LIN, Ningde (CN)

(73) Assignee: NINGDE AMPEREX TECHNOLOGY LIMITED, Ningde (CN)

(21) Appl. No.: 19/431,685

(22) Filed: Dec. 23, 2025

Related U.S. Application Data
(63) Continuation of application No. PCT/CN2023/102348, filed on Jun. 26, 2023.

(51) Int. Cl. H01M 4/62; H01G 11/28; H01G 11/50; H01M 4/02; H01M 4/133; H01M 4/134; H01M 4/38; H01M 4/587; H01M 10/0525

(52) U.S. Cl. CPC H01M 4/628; H01M 4/133; H01M 4/134; H01M 4/386; H01M 4/587; H01M 4/625; H01M 10/0525; H01G 11/28; H01G 11/50; H01M 2004/021; H01M 2004/027

(57) ABSTRACT

An electrochemical device includes a negative electrode plate. The negative electrode plate includes a negative electrode current collector, a first negative electrode active material layer, and a second negative electrode active material layer, and the first negative electrode active material layer is located between the negative electrode current collector and the second negative electrode active material layer. The first negative electrode active material layer includes a first silicon-based material, the second negative electrode active material layer includes a second silicon-based material, Dᵥ10 of the first silicon-based material is 3 μm to 10 μm, Dᵥ10 of the second silicon-based material is 1 μm to 4 μm, and Dᵥ10 refers to a particle size corresponding to a cumulative volume percentage of 10% in a volume-based particle size distribution starting from small particles.

### CROSS-REFERENCE TO RELATED APPLICATIONS

This application is a continuation application of International Application No. PCT/CN2023/102348, filed on Jun. 26, 2023, the content of which is incorporated herein by reference in its entirety.

### TECHNICAL FIELD

The present application relates to the field of electrochemical energy storage, and in particular, to an electrochemical device and an electronic device.

### BACKGROUND

With the widespread application of electrochemical devices (for example, lithium-ion batteries) in various electronic products, users have put forward increasingly high requirements for the rate performance and cycling performance of electrochemical devices. Therefore, further improvements are urgently needed to meet people's increasingly high usage demands.

### SUMMARY

An embodiment of the present application provides an electrochemical device, where the electrochemical device includes a negative electrode plate, the negative electrode plate includes a negative electrode current collector, a first negative electrode active material layer, and a second negative electrode active material layer, and the first negative electrode active material layer is located between the negative electrode current collector and the second negative electrode active material layer. The first negative electrode active material layer includes a first silicon-based material, the second negative electrode active material layer includes a second silicon-based material, Dᵥ10 of the first silicon-based material is 3 μm to 10 μm, and Dᵥ10 of the second silicon-based material is 1 μm to 4 μm. Dᵥ10 refers to a particle size corresponding to a cumulative volume percentage of 10% in a volume-based particle size distribution starting from small particles, so Dᵥ10 can reflect the level of small-sized particles in the material. A smaller Dᵥ10 indicates smaller particle sizes of small-sized particles in the material and also indicates a larger number of smaller-sized particles in the material.

In some embodiments, the Dᵥ10 of the first silicon-based material is 3 μm to 8 μm, and the Dᵥ10 of the second silicon-based material is 1 μm to 2 μm.

In some embodiments, based on a total mass of the first negative electrode active material layer, a mass percentage of the first silicon-based material in the first negative electrode active material layer is 5% to 20%; based on a total mass of the second negative electrode active material layer, a mass percentage of the second silicon-based material in the second negative electrode active material layer is 10% to 40%; and the mass percentage of the second silicon-based material in the second negative electrode active material layer is at least 5% greater than the mass percentage of the first silicon-based material in the first negative electrode active material layer.

In some embodiments, based on the total mass of the first negative electrode active material layer, the mass percentage of the first silicon-based material in the first negative electrode active material layer is 5% to 15%; and based on the total mass of the second negative electrode active material layer, the mass percentage of the second silicon-based material in the second negative electrode active material layer is 10% to 30%. In some embodiments, based on a total mass of the first negative electrode active material layer, a mass percentage of silicon element in the first negative electrode active material layer is 2% to 10%; based on a total mass of the second negative electrode active material layer, a mass percentage of silicon element in the second negative electrode active material layer is 4% to 18%; and the mass percentage of silicon element in the second negative electrode active material layer is at least 2% greater than the mass percentage of silicon element in the first negative electrode active material layer. In some embodiments, based on the total mass of the first negative electrode active material layer, the mass percentage of silicon element in the first negative electrode active material layer is 2% to 6.6%; and based on the total mass of the second negative electrode active material layer, the mass percentage of silicon element in the second negative electrode active material layer is 4% to 13.2%.

In some embodiments, the first negative electrode active material layer further includes a first conductive agent, and the second negative electrode active material layer further includes a second conductive agent; based on a total mass of the first negative electrode active material layer, a mass percentage of the first conductive agent in the first negative electrode active material layer is 0.05% to 2%; based on a total mass of the second negative electrode active material layer, a mass percentage of the second conductive agent in the second negative electrode active material layer is 0.2% to 1%; and the mass percentage of the second conductive agent in the second negative electrode active material layer is greater than or equal to the mass percentage of the first conductive agent in the first negative electrode active material layer. In some embodiments, based on the total mass of the second negative electrode active material layer, the mass percentage of the second conductive agent in the second negative electrode active material layer is 0.2% to 0.4%.

In some embodiments, the first silicon-based material and the second silicon-based material each independently include at least one of silicon oxide, silicon carbon, or pure silicon; and the first conductive agent and the second conductive agent each independently include at least one of conductive carbon black, carbon nanotubes, metal particles, or carbon fibers.

An embodiment of the present application further provides an electronic device, including the foregoing electrochemical device.

According to the present application, by making the Dᵥ10 of the first silicon-based material be 3 μm to 10 μm and the Dᵥ10 of the second silicon-based material be 1 μm to 4 μm, lithium precipitation issues can be alleviated and the cycling swelling rate can be improved for the negative electrode plate of the electrochemical device, increasing the cycling capacity retention rate of the electrochemical device.

### BRIEF DESCRIPTION OF DRAWINGS

FIG. 1 is a cross-sectional view of a negative electrode plate taken along a width direction according to some embodiments.

### DETAILED DESCRIPTION

The following embodiments enable those skilled in the art to more fully understand the present application, but do not limit the present application in any way.

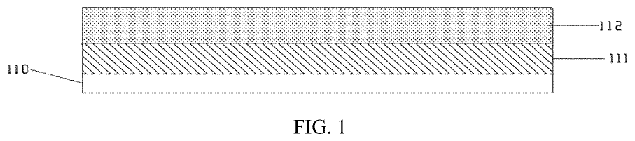

An embodiment of the present application provides an electrochemical device, where the electrochemical device includes a negative electrode plate. In some embodiments, the negative electrode plate includes a negative electrode current collector 110, a first negative electrode active material layer 111, and a second negative electrode active material layer 112, and the first negative electrode active material layer 111 is located between the negative electrode current collector 110 and the second negative electrode active material layer 112. In some embodiments, the first negative electrode active material layer 111 and the second negative electrode active material layer 112 may be present on one side of the negative electrode current collector 110 (as shown in FIG. 1), or the first negative electrode active material layer 111 and the second negative electrode active material layer 112 may be present on both sides ofthe negative electrode current collector 110 (not shown).

In some embodiments, the first negative electrode active material layer 111 includes a first negative electrode active material, and the first negative electrode active material includes a first silicon-based material. In some embodiments, the second negative electrode active material layer 112 includes a second negative electrode active material, and the second negative electrode active material includes a second silicon-based material. In some embodiments, Dᵥ10 of the first silicon-based material is 3 μm to 10 μm, Dᵥ10 of the second silicon-based material is 1 μm to 4 μm, Dᵥ10 refers to a particle size corresponding to a cumulative volume percentage of 10% in a volume-based particle size distribution starting from small particles, and the value of Dᵥ10 reflects the level of small particles in the material.

In some embodiments, if the Dᵥ10 of the first silicon-based material is too small, due to an excessive proportion of small-sized particles of the first silicon-based material, a side reaction area increases, which deteriorates cycling performance and increases electrolyte consumption during cycling. If the Dᵥ10 of the first silicon-based material is too large, when the Dᵥ10 of the second silicon-based material is relatively large, it indicates that the fine particle content of the first silicon-based material is too low, mainly consisting of large particle sizes, resulting in a relatively large diffusion distance for lithium ions within the particles. This adversely affects the overall rate performance of the electrochemical device, causing lithium precipitation in different parts of the electrochemical device. In some embodiments, if the Dᵥ10 of the second silicon-based material is too small, due to an excessive proportion of small-sized particles of the second silicon-based material, a side reaction area increases, which deteriorates cycling performance and increases electrolyte consumption during cycling. If the Dᵥ10 of the second silicon-based material is too large, it adversely affects the rate performance of the electrochemical device. In addition, since the Dᵥ10 of the first silicon-based material is at least 2 μm greater than the Dᵥ10 of the second silicon-based material, the larger Dᵥ10 of the first silicon-based material is beneficial for increasing energy density of the negative electrode plate, while typically, the second negative electrode active material layer 112 is located on a surface of the negative electrode plate, and the smaller Dᵥ10 of the second silicon-based material is beneficial for improving rate performance of the electrochemical device and reducing lithium precipitation. This is because the lithium intercalation reaction of silicon-based materials is an alloying reaction, with bottlenecks in SEI film impedance and solid-phase diffusion coefficient of material particles. When Dᵥ10 is relatively small, the proportion of small particles in the silicon-based material is high, which is beneficial for increasing reaction area, reducing lithium ion diffusion distance inside particles, and alleviating lithium precipitation.

In some embodiments, the Dᵥ10 of the first silicon-based material is 3 μm to 8 μm, and the Dᵥ10 of the second silicon-based material is 1 μm to 2 μm. At this time, the rate performance of the electrochemical device is relatively good, no lithium precipitation occurs, the cycling capacity retention rate is relatively high, and the cycling swelling rate is relatively small.

In some embodiments, based on a total mass of the first negative electrode active material layer 111, a mass percentage of the first silicon-based material in the first negative electrode active material layer 111 is 5% to 20%; and based on a total mass of the second negative electrode active material layer 112, a mass percentage of the second silicon-based material in the second negative electrode active material layer 112 is 10% to 40%. Typically, the higher the mass percentage of the first silicon-based material in the first negative electrode active material layer 111 or the mass percentage of the second silicon-based material in the second negative electrode active material layer 112, the corresponding coating can adopt a smaller thickness while maintaining the same capacity, thereby reducing lithium precipitation. However, as the mass percentage of the silicon-based material in the corresponding coating increases, the cycling capacity retention rate and cycling swelling rate of the electrochemical device deteriorate somewhat. In some embodiments, the mass percentage of the second silicon-based material in the second negative electrode active material layer 112 is at least 5% greater than the mass percentage of the first silicon-based material in the first negative electrode active material layer 111, so that the second negative electrode active material layer 112 with a higher mass percentage of the second silicon-based material can maintain a smaller thickness while keeping the same capacity, which is beneficial for reducing lithium precipitation.

In some embodiments, based on the total mass of the first negative electrode active material layer 111, the mass percentage of the first silicon-based material in the first negative electrode active material layer 111 is 5% to 15%; and based on the total mass of the second negative electrode active material layer 112, the mass percentage of the second silicon-based material in the second negative electrode active material layer 112 is 10% to 30%. At this time, the rate performance of the electrochemical device is relatively good, no lithium precipitation occurs, the cycling capacity retention rate is relatively high, and the cycling swelling rate is relatively small.

In some embodiments, based on a total mass of the first negative electrode active material layer 111, a mass percentage of silicon element in the first negative electrode active material layer 111 is 2% to 10%; and based on a total mass of the second negative electrode active material layer 112, a mass percentage of silicon element in the second negative electrode active material layer 112 is 4% to 18%. Typically, the higher the mass percentage of silicon element in the first negative electrode active material layer 111 or the mass percentage of silicon element in the second negative electrode active material layer 112, the corresponding coating can adopt a smaller thickness while maintaining the same capacity, thereby reducing lithium precipitation. However, as the mass percentage of silicon element in the corresponding coating increases, the cycling capacity retention rate and cycling swelling rate of the electrochemical device deteriorate somewhat. In some embodiments, the mass percentage of silicon element in the second negative electrode active material layer 112 is at least 2% greater than the mass percentage of silicon element in the first negative electrode active material layer 111. In this way, the second negative electrode active material layer 112 with a higher mass percentage of silicon element can maintain a smaller thickness while keeping the same capacity, which is beneficial for reducing lithium precipitation.

In some embodiments, based on the total mass of the first negative electrode active material layer 111, the mass percentage of silicon element in the first negative electrode active material layer 111 is 2% to 6.6%; and based on the total mass of the second negative electrode active material layer 112, the mass percentage of silicon element in the second negative electrode active material layer 112 is 4% to 13.2%. At this time, the rate performance of the electrochemical device is relatively good, no lithium precipitation occurs, the cycling capacity retention rate is relatively high, and the cycling swelling rate is relatively small.

In some embodiments, the first negative electrode active material layer 111 further includes a first conductive agent, and the second negative electrode active material layer 112 further includes a second conductive agent. In some embodiments, based on a total mass of the first negative electrode active material layer 111, a mass percentage of the first conductive agent in the first negative electrode active material layer 111 is 0.05% to 2%; and based on a total mass of the second negative electrode active material layer 112, a mass percentage of the second conductive agent in the second negative electrode active material layer 112 is 0.2% to 1%, and the mass percentage of the second conductive agent in the second negative electrode active material layer 112 is greater than or equal to the mass percentage of the first conductive agent in the first negative electrode active material layer 111. The mass percentage of the second conductive agent in the second negative electrode active material layer 112 is greater than or equal to the mass percentage of the first conductive agent in the first negative electrode active material layer 111, helping to improve the cycling swelling rate of the electrochemical device. In some embodiments, based on the total mass of the second negative electrode active material layer 112, the mass percentage of the second conductive agent in the second negative electrode active material layer 112 is 0.2% to 0.4%. At this time, the rate performance of the electrochemical device is relatively good, no lithium precipitation occurs, the cycling capacity retention rate is relatively high, and the cycling swelling rate is relatively small.

In some embodiments, a thickness of the first negative electrode active material layer 111 is 40 μm to 180 μm. In some embodiments, the thickness of the first negative electrode active material layer 111 is 40 μm to 100 μm. When the first negative electrode active material layer 111 is too thick, it affects lithium ion conduction distance and charging capability; and when the first negative electrode active material layer 111 is too thin, energy density of the electrochemical device decreases. In some embodiments, a thickness of the second negative electrode active material layer 112 is 20 μm to 50 μm. In some embodiments, the thickness of the second negative electrode active material layer 112 is 20 μm to 40 μm. When the second negative electrode active material layer 112 is too thick, it affects lithium ion conduction distance and charging capability; and when the second negative electrode active material layer 112 is too thin, energy density of the electrochemical device decreases.

In some embodiments, the negative electrode current collector 110 may use at least one of copper foil, nickel foil, or carbon-based current collector. In some embodiments, the first silicon-based material and the second silicon-based material each independently include at least one of silicon oxide, silicon carbon, or pure silicon. In some embodiments, the first conductive agent and the second conductive agent each independently include at least one of conductive carbon black, carbon nanotubes, metal particles, or carbon fibers. In some embodiments, the first negative electrode active material layer 111 and the second negative electrode active material layer 112 may each independently include graphite, for example, artificial graphite and natural graphite.

In some embodiments, the first negative electrode active material layer 111 further includes a first binder, and a mass percentage of the first binder in the first negative electrode active material layer 111 is 1% to 6%. In some embodiments, the second negative electrode active material layer 112 further includes a second binder, and a mass percentage of the second binder in the second negative electrode active material layer 112 is 0.5% to 5%. In some embodiments, the mass percentage of the second binder in the second negative electrode active material layer 112 is 1% to 4%. In some embodiments, the mass percentage of the second binder in the second negative electrode active material layer 112 is greater than the mass percentage of the first binder in the first negative electrode active material layer 111. When the mass percentage of the first binder in the first negative electrode active material layer 111 or the mass percentage of the second binder in the second negative electrode active material layer 112 is too low, although charging capability improves, there is a risk of delamination in the negative electrode plate; and when the mass percentage of the first binder in the first negative electrode active material layer 111 or the mass percentage of the second binder in the second negative electrode active material layer 112 is too high, charging capability deteriorates, leading to lithium precipitation during high-rate charging and discharging. In some embodiments, the first binder and the second binder each independently include at least one of styrene-butadiene rubber (SBR), lithium polyacrylate, sodium polyacrylate, polyurethane, polyvinyl alcohol, or polyvinylidene fluoride (PVDF).

In some embodiments, a mass ratio of the first negative electrode active material, binder, and conductive agent in the first negative electrode active material layer 111 may be (90 to 98):(1 to 5):(1 to 5). In some embodiments, a mass ratio of the second negative electrode active material, binder, and conductive agent in the second negative electrode active material layer 112 may be (90 to 98):(1 to 5):(1 to 5). It should be understood that the component ratios of the first negative electrode active material layer 111 and the second negative electrode active material layer 112 described above are only examples, and any other suitable mass ratios may be adopted.

In some embodiments, the electrochemical device may further include a positive electrode plate and a separator, and the separator is disposed between the positive electrode plate and the negative electrode plate to provide isolation.

In some embodiments, the positive electrode plate includes a positive electrode current collector and a positive electrode active material layer, and the positive electrode active material layer is located on one side or both sides of the positive electrode current collector. In some embodiments, the positive electrode current collector may use aluminum foil, or certainly, other positive electrode current collectors commonly used in the art may be used. In some embodiments, a thickness of the positive electrode current collector may be 5 μm to 30 μm.

In some embodiments, the positive electrode active material layer may include a positive electrode active material, a conductive agent, and a binder. In some embodiments, the positive electrode active material may include at least one of lithium cobalt oxide, lithium iron phosphate, lithium aluminate, lithium manganate, or lithium nickel cobalt manganate. In some embodiments, the conductive agent in the positive electrode active material layer may include at least one of conductive carbon black, lamellar graphite, graphene, or carbon nanotubes. In some embodiments, the binder in the positive electrode active material layer may include at least one of polyvinylidene fluoride, copolymer of vinylidene fluoride-hexafluoropropylene, styrene-acrylate copolymer, styrene-butadiene copolymer, polyamide, polyacrylonitrile, polyacrylate, polyacrylic acid, polyacrylate salt, sodium carboxymethyl cellulose, polyvinyl acetate, polyvinyl pyrrolidone, polyvinyl ether, polymethyl methacrylate, polytetrafluoroethylene, or polyhexafluoropropylene. In some embodiments, a mass ratio of the positive electrode active material, conductive agent, and binder in the positive electrode active material layer is (90-99):(0.5-5):(0.5-5), but this is only an example, and any other suitable mass ratio may be adopted.

In some embodiments, the separator includes at least one of polyethylene, polypropylene, polyvinylidene fluoride, polyethylene terephthalate, polyimide, or aramid. For example, polyethylene includes at least one selected from high-density polyethylene, low-density polyethylene, or ultra-high molecular weight polyethylene. Especially polyethylene and polypropylene, they have a good effect on preventing short circuits and can improve the stability of the battery through a shutdown effect. In some embodiments, a thickness of the separator is in a range of about 3 μm to 20 μm.

In some embodiments, a surface of the separator may also include a porous layer, the porous layer is disposed on at least one surface of the separator, the porous layer includes inorganic particles and a binder, and the inorganic particles are selected from at least one of aluminum oxide (Al₂O₃), silicon oxide (SiO₂), magnesium oxide (MgO), titanium oxide (TiO₂), hafnium dioxide (HfM₂), tin oxide (SnO₂), cerium dioxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. In some embodiments, pores of the separator have a diameter in a range of about 0.01 μm to 1 μm. The binder of the porous layer is selected from at least one of polyvinylidene fluoride, copolymer of vinylidene fluoride-hexafluoropropylene, polyamide, polyacrylonitrile, polyacrylate, polyacrylic acid, polyacrylate salt, sodium carboxymethyl cellulose, polyvinyl pyrrolidone, polyvinyl ether, polymethyl methacrylate, polytetrafluoroethylene, or polyhexafluoropropylene. The porous layer on the surface of the separator can enhance heat resistance, oxidation resistance, and electrolyte wetting performance of the separator, and enhance adhesion between the separator and the electrode plate.

In some embodiments, the electrochemical device includes a lithium-ion battery, but the present application is not limited thereto. In some embodiments, the electrochemical device further includes an electrolyte, and the electrolyte includes at least one of fluoroether, fluoroethylene carbonate, or ether nitrile. In some embodiments, the electrolyte further includes lithium salt, the lithium salt includes lithium bis(fluorosulfonyl)imide and lithium hexafluorophosphate, and a concentration of the lithium salt is 1 mol/L to 2 mol/L. In some embodiments, the electrolyte may further include a non-aqueous solvent. The non-aqueous solvent may be a carbonate compound, a carboxylate compound, an ether compound, other organic solvents, or combinations thereof.

The carbonate compound may be a chain carbonate compound, a cyclic carbonate compound, a fluorocarbonate compound, or a combination thereof.

Examples of the chain carbonate compound are diethyl carbonate (DEC), dimethyl carbonate (DMC), dipropyl carbonate (DPC), methyl propyl carbonate (MPC), ethyl propyl carbonate (EPC), methyl ethyl carbonate (MEC), and combinations thereof. Examples of the cyclic carbonate compound are ethylene carbonate (EC), propylene carbonate (PC), butylene carbonate (BC), vinyl ethylene carbonate (VEC), or combinations thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene carbonate, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or combinations thereof.

Examples of the carboxylate compound are methyl acetate, ethyl acetate, n-propyl acetate, tert-butyl acetate, methyl propionate, ethyl propionate, propyl propionate, γ-butyrolactone, decalactone, valerolactone, mevalonolactone, caprolactone, methyl formate, or combinations thereof.

Examples of the ether compound are dibutyl ether, tetraglyme, diglyme, 1,2-dimethoxyethane, 1,2-diethoxyethane, ethoxymethoxyethane, 2-methyltetrahydrofuran, tetrahydrofuran, or combinations thereof.

Examples of other organic solvents are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, and phosphate esters or combinations thereof.

An embodiment of the present application also provides an electronic device including the foregoing electrochemical device. The electronic device of this embodiment of the present application is not particularly limited, and it may be any electronic device known in the prior art. In some embodiments, the electronic device may include, but is not limited to, notebook computers, pen-input computers, mobile computers, e-book players, portable phones, portable fax machines, portable copiers, portable printers, head-mounted stereo headphones, video recorders, LCD TVs, portable cleaners, portable CD players, mini discs, transceivers, electronic notebooks, calculators, memory cards, portable recorders, radios, backup power supplies, motors, automobiles, motorcycles, power-assisted bicycles, bicycles, drones, lighting appliances, toys, game consoles, clocks, power tools, flashlights, cameras, large household storage batteries, and lithium-ion capacitors.

The following lists some specific examples and comparative examples to better illustrate the present application, where lithium-ion batteries are used as examples.

### Comparative Example 1

Preparation of negative electrode plate: Negative electrode active material silicon carbon (Dᵥ10 was 12 μm), artificial graphite, binder styrene-butadiene rubber, and conductive carbon black were dissolved in deionized water at a weight ratio of 5:93.3:1.5:0.2 to form a first slurry. 6 μm thick copper foil was used as a negative electrode current collector, and the first slurry was applied to both sides of the negative electrode current collector to obtain a first negative electrode active material layer. Negative electrode active material silicon carbon (Dᵥ10 was 3 μm), artificial graphite, binder styrene-butadiene rubber, and conductive carbon black were dissolved in deionized water at a weight ratio of 10:86.5:3:0.5 to form a second slurry. The second slurry was applied to the first negative electrode active material layer to obtain a second negative electrode active material layer. After drying, cold pressing, and slitting, a negative electrode plate was obtained. The thickness of the first negative electrode active material layer was 50 μm, and the thickness of the second negative electrode active material layer was 50 μm.

Preparation of positive electrode plate: Positive electrode active material lithium cobalt oxide, conductive agent conductive carbon black, and binder polyvinylidene fluoride (PVDF) were dissolved in N-methylpyrrolidone (NMP) solution at a weight ratio of 94:3:3 to form a positive electrode slurry. 8 μm thick aluminum foil was used as a positive electrode current collector, and the positive electrode slurry was applied to both sides of the positive electrode current collector, with a coating thickness of 80 μm each. After drying, cold pressing, and slitting, a positive electrode plate was obtained.

Preparation of separator: A separator substrate was 8 μm thick polyethylene (PE), and 2 μm aluminum oxide ceramic layer was applied to both sides of the separator substrate. Finally, 2.5 mg/1540.25 mm² of binder polyvinylidene fluoride (PVDF) was applied to both sides coated with the ceramic layer and dried.

Preparation of electrolyte: In an environment with water content less than ppm, lithium hexafluorophosphate was prepared with non-aqueous organic solvent (ethylene carbonate (EC):diethyl carbonate (DEC):propylene carbonate (PC):propyl propionate (PP):vinylene carbonate (VC)=20:30:20:28:2, at mass percentage) to obtain an electrolyte with a lithium salt concentration of 1.15 mol/L.

Preparation of lithium-ion battery: The positive electrode plate, separator, and negative electrode plate were stacked in order, with the separator located between the positive electrode plate and the negative electrode plate for isolation, and wound to obtain an electrode assembly. The electrode assembly was placed in an outer packaging aluminum-plastic film, moisture was removed at 80° C., the above electrolyte was injected and encapsulated, and a lithium-ion battery was obtained through processes such as formation, degassing, and shaping.

The parameters of Comparative Examples 2-5 and Examples 1 to 19 differed from Comparative Example 1 in some parameters in the preparation of the negative electrode plate. For specific differences, refer to Table 1 and Table 2.

The following describes the test methods for various parameters of the present application.

### Particle Size Distribution Test:

0.02 g powder sample (the powder was silicon-based material, and the silicon-based material could be purchased during production or separated from the negative electrode plate) was added to a 50 ml clean beaker, about 20 ml deionized water was added, then a few drops of 1% surfactant were added to fully disperse the powder in water, and ultrasonicated for 5 min in a 120 W ultrasonic cleaner, and the particle size distribution was tested using MasterSizer 2000. The Dᵥ10 of the sample was calculated from the volume-based particle size distribution curve obtained by laser scattering particle size analyzer.

### Cycling Performance Test:

The battery was left to stand for 30 min in a 25±3° C. environment, charged at a constant current of 3C (1C was the rated capacity of the battery) as the maximum current to an upper limit cut-off voltage of the battery, and switched to constant voltage charging. Charging was stopped when the current reached 0.05C, and the battery was left to stand for 30 min. The battery was then discharged to 3.0V at a current of 0.5C and left to stand for 30 min. The battery was cycled 500 times according to the same charging and discharging process, and the discharge capacity of each cycle divided by the first discharge capacity was taken as the capacity retention rate.

### Cycling Swelling Rate Test:

A flat thickness gauge (with a load of 600 g) was used to test the thickness of a fresh lithium-ion battery at half charge (at 50% state of charge (SOC)). After 500 cycles, the lithium-ion battery was in full charge state (at 100% SOC), the thickness of the lithium-ion battery was tested again with the flat thickness gauge, and compared with the initial half-charge thickness to get the cycling swelling rate of the full-charge lithium-ion battery at this time.

### Lithium Precipitation Test:

At 25° C., the lithium-ion battery was charged to the upper limit cut-off voltage at a constant current of 3C. The battery was then charged at constant voltage of the upper limit cut-off voltage to a current of 0.05C, left to stand for 2 min, then discharged to 3.0V at a constant current of 0.5C, and left to stand for 2 min. This was one cycle. After 10 cycles were repeated, the lithium-ion battery was disassembled to obtain the electrode assembly. The electrode assembly was spread flat, and if any region larger than 2 mm² on the negative electrode plate had lithium precipitation, it was determined as lithium precipitation on the negative electrode plate, where the edge region was the region where the negative electrode plate exceeded the positive electrode (generally the region within 0.2 mm to 1.5 mm from the end of the negative electrode plate toward the middle of the negative electrode plate), and the main region was the region on the negative electrode plate overlapping with the positive electrode plate.

### Silicon Content Test Method:

Silicon element content test: Powder was scraped from the negative electrode plate to obtain 0.10 g powder, the powder was put into a nickel crucible, 1.2 g to 1.5 g KOH was added, a crucible lid was covered, a muffle furnace was slowly heated to 400° C., and the heating program was 2 h from room temperature to 300° C. and 2 h from 300° C. to 400° C. Cooling was started, the digestion program was ended, and the crucible was taken out. After the burned crucible cooled to about 100° C., it was taken out and placed in a beaker, 30 ml boiling water was slowly added for leaching for 1 h. Tweezers were used to clip the crucible for cleaning, with the volume controlled to 50 ml, and filtration was performed to 400 ml beaker, where attention was paid to control the solution volume during transfer. After filtration, 20 ml concentrated nitric acid was added at once to neutralize the solution, making the solution acidic. After the test solution cooled to room temperature, solid KCl was added to saturation under constant stirring, and excess 2 g. A 10 mL potassium fluoride solution was added, and white precipitate appeared after the adding of the potassium fluoride, aged for 15 min, and filtered with medium-speed quantitative filter paper. The beaker and precipitate were washed with 8 mL potassium chloride solution each time, washed three times in total. The filter paper was removed and put back in the original beaker. 20 mL potassium chloride ethanol solution and 10 drops of phenolphthalein were added, and residual acid was neutralized with a standard sodium hydroxide solution. The filter paper was carefully stirred and the cup wall was scrubbed until the solution was light red, and a glass rod was used to crush the pulp as much as possible to make the reaction complete. 200 ml neutralized boiling water was added to the cup, and after boiling, 10 drops of phenolphthalein were added. The solution was neutralized with the standard sodium hydroxide solution until a faint pink color appeared. It was then titrated with the standard sodium hydroxide solution to a light pink endpoint, and the titration consumption volume was recorded. The silicon content was calculated according to the following formula:
ωsi=(V−V0)×c×0.0072/m×100%, where c was the concentration of the standard sodium hydroxide solution, in mol/L; V was the volume of the standard sodium hydroxide solution consumed in titration, V0 was the volume of the standard sodium hydroxide solution consumed in blank, 0.0072 was the molar mass of ¼ Si, and m was the sample mass, in g.

When the silicon content in the second negative electrode active material layer was measured, a scraper was used to scrape the powder within 10 μm thickness range of the negative electrode plate near the surface layer. When the silicon content in the first negative electrode active material layer was measured, a scraper was used to scrape the powder within 10 sm thickness range of the negative electrode plate near the surface of the negative electrode current collector.

Further, for different silicon materials, the above method can be applied to test for silicon element to obtain the mass percentage of the silicon-based material.

Table 1 and Table 2 show various parameters and evaluation results of Examples 1 to 19 and Comparative Examples 1 to 5.

TABLE 1

| | | Mass | | Mass | | | | |
|---|---|---|---|---|---|---|---|---|
| | | percentage | | percentage | | | | |
| | Mass | of first | Mass | of second | | | | |
| | percentage | silicon- | percentage | silicon- | | | | |
| | of silicon | based | of silicon | based | | | | |
| | element in | material in | element in | material in | | | Thickness | Thickness |
| | first | first | second | second | Dᵥ10 of | Dᵥ10 of | of first | of second |
| | negative | negative | negative | negative | first | second | negative | negative |
| | electrode | electrode | electrode | electrode | silicon- | silicon- | electrode | electrode |
| | active | active | active | active | based | based | active | active |
| | material | material | material | material | material | material | material | material |
| | layer | layer | layer | layer | (μm) | (μm) | (μm) | (μm) |
| Example 1 | 2.20% | 5% | 4.4% | 10% | 3 | 1 | 50 | 50 |
| Example 2 | 2.20% | 5% | 4.4% | 10% | 4 | 2 | 50 | 50 |
| Example 3 | 2.20% | 5% | 4.4% | 10% | 6 | 2 | 50 | 50 |
| Example 4 | 2.20% | 5% | 4.4% | 10% | 8 | 2 | 50 | 50 |
| Example 5 | 2.20% | 5% | 4.4% | 10% | 6 | 3 | 50 | 50 |
| Example 6 | 2.20% | 5% | 4.4% | 10% | 8 | 4 | 50 | 50 |
| Example 7 | 2.20% | 5% | 4.4% | 10% | 10 | 3 | 50 | 50 |
| Comparative | 2.20% | 5% | 4.4% | 10% | 12 | 3 | 50 | 50 |
| example 1 | | | | | | | | |
| Comparative | 2.20% | 5% | 4.4% | 10% | 8 | 5 | 50 | 50 |
| example 2 | | | | | | | | |
| Comparative | 2.20% | 5% | 4.40% | 10% | 12 | 5 | 50 | 50 |
| example 3 | | | | | | | | |
| Comparative | 2.20% | 5% | 4.40% | 10% | 2 | 0.5 | 50 | 50 |
| example 4 | | | | | | | | |
| Comparative | 2.20% | 5% | 4.40% | 10% | 6 | 0.5 | 50 | 50 |
| example 5 | | | | | | | | |
| Example 8 | 4.40% | 10% | 8.8% | 20% | 6 | 2 | 55 | 45 |
| Example 9 | 5.70% | 13% | 8.8% | 20% | 6 | 2 | 60 | 40 |
| Example 10 | 6.60% | 15% | 13.2% | 30% | 6 | 2 | 65 | 35 |
| Example 11 | 7.90% | 18% | 15.8% | 36% | 6 | 2 | 70 | 30 |
| Example 12 | 8.80% | 20% | 17.6% | 40% | 6 | 2 | 75 | 25 |
| Example 13 | 9.7% | 22% | 17.6% | 40% | 6 | 2 | 80 | 20 |
| Example 14 | 2.20% | 5% | 4.4% | 10% | 8 | 2 | 50 | 50 |
| Example 15 | 2.20% | 5% | 4.4% | 10% | 8 | 2 | 50 | 50 |
| Example 16 | 2.20% | 5% | 4.4% | 10% | 8 | 2 | 50 | 50 |
| Example 17 | 2.20% | 5% | 4.4% | 10% | 8 | 2 | 50 | 50 |
| Example 18 | 2.20% | 5% | 4.4% | 10% | 8 | 2 | 50 | 50 |
| Example 19 | 2.20% | 5% | 4.4% | 10% | 8 | 2 | 50 | 50 |

TABLE 2

| | | Mass | | Mass | | | |
|---|---|---|---|---|---|---|---|
| | Mass | percentage of | | percentage | | | |
| | percentage of | second | | of second | | | |
| | first | conductive | Mass | binder in | | | |
| | conductive | agent in | percentage of | second | | | |
| | agent in first | second | first binder in | negative | | Cycling | |
| | negative | negative | first negative | electrode | Lithium | capacity | Cycling |
| | electrode | electrode | electrode | active | precipitation | retention | swelling |
| | active | active | active | material | disassembly | rate after | rate after |
| | material layer | material layer | material layer | layer | situation | 500 cycles | 500 cycles |
| Example 1 | 0.20% | 0.50% | 1.50% | 3.00% | No lithium | 88.50% | 10.50% |
| | | | | | precipitation | | |
| Example 2 | 0.20% | 0.50% | 1.50% | 3.00% | No lithium | 89.50% | 10.30% |
| | | | | | precipitation | | |
| Example 3 | 0.20% | 0.50% | 1.50% | 3.00% | No lithium | 90.20% | 9.50% |
| | | | | | precipitation | | |
| Example 4 | 0.20% | 0.50% | 1.50% | 3.00% | No lithium | 91.30% | 9.20% |
| | | | | | precipitation | | |
| Example 5 | 0.20% | 0.50% | 1.50% | 3.00% | Mild lithium | 85.50% | 10.40% |
| | | | | | precipitation | | |
| | | | | | at edges | | |
| Example 6 | 0.20% | 0.50% | 1.50% | 3.00% | Moderate | 86.50% | 10.20% |
| | | | | | lithium | | |
| | | | | | precipitation | | |
| | | | | | at edges and | | |
| | | | | | mild lithium | | |
| | | | | | precipitation | | |
| | | | | | in main | | |
| | | | | | region | | |
| Example 7 | 0.20% | 0.50% | 1.50% | 3.00% | Moderate | 85.50% | 11.20% |
| | | | | | lithium | | |
| | | | | | precipitation | | |
| | | | | | at edges and | | |
| | | | | | mild lithium | | |
| | | | | | precipitation | | |
| | | | | | in main | | |
| | | | | | region | | |
| Comparative | 0.20% | 0.50% | 1.50% | 3.00% | Moderate | 84.50% | 11.40% |
| example 1 | | | | | lithium | | |
| | | | | | precipitation | | |
| | | | | | at edges and | | |
| | | | | | moderate | | |
| | | | | | lithium | | |
| | | | | | precipitation | | |
| | | | | | in main | | |
| | | | | | region | | |
| Comparative | 0.20% | 0.50% | 1.50% | 3.00% | Moderate | 82.10% | 12.50% |
| example 2 | | | | | lithium | | |
| | | | | | precipitation | | |
| | | | | | at edges and | | |
| | | | | | moderate | | |
| | | | | | lithium | | |
| | | | | | precipitation | | |
| | | | | | in main | | |
| | | | | | region | | |
| Comparative | 0.20% | 0.50% | 1.50% | 3.00% | Severe | 73.50% | 14.50% |
| example 3 | | | | | lithium | | |
| | | | | | precipitation | | |
| | | | | | at edges and | | |
| | | | | | severe | | |
| | | | | | lithium | | |
| | | | | | precipitation | | |
| | | | | | in main | | |
| | | | | | region | | |
| Comparative | 0.20% | 0.50% | 1.50% | 3.00% | No lithium | 76.50% | 13.40% |
| example 4 | | | | | precipitation | | |
| Comparative | 0.20% | 0.50% | 1.50% | 3.00% | No lithium | 79.50% | 12.50% |
| example 5 | | | | | precipitation | | |
| Example 8 | 0.20% | 0.50% | 1.50% | 3.00% | No lithium | 82.50% | 11.00% |
| | | | | | precipitation | | |
| Example 9 | 0.20% | 0.50% | 1.50% | 3.00% | No lithium | 81.20% | 11.50% |
| | | | | | precipitation | | |
| Example 10 | 0.20% | 0.50% | 1.50% | 3.00% | No lithium | 79.50% | 12.80% |
| | | | | | precipitation | | |
| Example 11 | 0.20% | 0.50% | 1.50% | 3.00% | No lithium | 78.50% | 14.60% |
| | | | | | precipitation | | |
| Example 12 | 0.20% | 0.50% | 1.50% | 3.00% | No lithium | 76.60% | 16.50% |
| | | | | | precipitation | | |
| Example 13 | 0.20% | 0.50% | 1.50% | 3.00% | No lithium | 74.50% | 16.50% |
| | | | | | precipitation | | |
| Example 14 | 0.20% | 0.20% | 1.50% | 3.00% | No lithium | 83.50% | 9.20% |
| | | | | | precipitation | | |
| Example 15 | 0.20% | 0.30% | 1.50% | 3.00% | No lithium | 85.60% | 9.20% |
| | | | | | precipitation | | |
| Example 16 | 0.20% | 0.40% | 1.50% | 3.00% | No lithium | 87.50% | 9.20% |
| | | | | | precipitation | | |
| Example 17 | 0.20% | 1.00% | 1.50% | 3.00% | Mild lithium | 82.50% | 10.50% |
| | | | | | precipitation | | |
| Example 18 | 1.00% | 0.50% | 1.50% | 3.00% | Mild lithium | 84.30% | 11.50% |
| | | | | | precipitation | | |
| Example 19 | 2.00% | 0.50% | 1.50% | 3.00% | Mild lithium | 82.50% | 12.50% |
| | | | | | precipitation | | |

By comparing Examples 1 to 7 with Comparative Examples 1 to 5, it can be seen that when the Dᵥ10 of the first silicon-based material is 3 μm to 10 μm and the Dᵥ10 of the second silicon-based material is 1 μm to 4 μm, lithium precipitation of the lithium-ion battery is alleviated, and its cycling capacity retention rate and cycling swelling rate are also within an acceptable range (since the cycling capacity retention rate and cycling swelling rate of lithium-ion batteries containing silicon-based materials in the negative electrode plate are lower than those of pure graphite lithium-ion batteries, the acceptable level is also lower). As the Dᵥ10 of the first silicon-based material and/or the Dᵥ10 of the second silicon-based material increases, the difficulty of lithium ion intercalation increases, making lithium precipitation prone to occur. When the Dᵥ10 of the first silicon-based material is 3 μm to 8 μm and the Dᵥ10 of the second silicon-based material is 1 μm to 3 μm, lithium precipitation can be significantly alleviated, and cycling performance is also better. Dᵥ10 can indicate the level of small-sized particles in the material. A smaller Dᵥ10 indicates smaller particle sizes of small-sized particles in the material, or a larger Dᵥ10 indicates larger particles in the material with a smaller proportion of small particles. The Dᵥ10 of the first silicon-based material and the Dᵥ10 of the second silicon-based material being within the ranges indicate that the first silicon-based material has a smaller amount of small-sized particles, and the second silicon-based material has a larger amount of small-sized particles. Since the second silicon-based material is in the surface layer of the negative electrode plate, small-sized silicon-based materials have a larger contact area with the electrolyte, which is more beneficial for lithium ion intercalation and deintercalation, thus alleviating lithium precipitation. The first silicon-based material is distributed in the lower layer of the negative electrode plate, with a smaller amount of small-sized particles, which can balance the reaction rate of the overall negative electrode plate with the electrolyte, thereby improving the cycling retention rate. By comparing Examples 2 to 4, it can be seen that when the Dᵥ10 of the second silicon-based material is the same, as the Dᵥ10 of the first silicon-based material increases, the cycling capacity retention rate of the lithium-ion battery improves, and the cycling swelling rate decreases.

By comparing Examples 8 to 13, it can be seen that as the mass percentage of the first silicon-based material in the first negative electrode active material layer or the mass percentage of the second silicon-based material in the second negative electrode active material layer increases, the cycling capacity retention rate of the lithium-ion battery decreases, and the cycling swelling rate increases. Since silicon-based materials have a relatively large gram capacity but are prone to expansion during cycling, to balance volumetric energy density, silicon-based materials can be appropriately increased while the thickness of the first negative electrode active material layer or the second negative electrode active material layer is reduced, thereby also alleviating lithium precipitation.

By comparing Examples 14 to 17, it can be seen that as the mass percentage of the second conductive agent in the second negative electrode active material layer increases, the cycling capacity retention rate of the lithium-ion battery first increases and then decreases, and the cycling swelling rate first remains unchanged and then increases. By comparing Examples 18 and 19, it can be seen that as the mass percentage of the first conductive agent in the first negative electrode active material layer increases, the cycling capacity retention rate of the lithium-ion battery decreases, and the cycling swelling rate increases.

The above description presents only preferred embodiments of the present application and explains the applied technical principles. Those skilled in the art shall understand that the scope of disclosure in this application is not limited to technical solutions formed by specific combinations of the above-described technical features, but also covers other technical solutions formed through any combination of the technical features or their equivalent features. This includes, for example, technical solutions where the aforementioned features are interchangeably substituted with technical features having similar functions disclosed in this application.

What is claimed is:

1. An electrochemical device, comprising a negative electrode plate, wherein
the negative electrode plate comprises a negative electrode current collector, a first negative electrode active material layer, and a second negative electrode active material layer; the first negative electrode active material layer is located between the negative electrode current collector and the second negative electrode active material layer; and
the first negative electrode active material layer comprises a first silicon-based material, the second negative electrode active material layer comprises a second silicon-based material, Dᵥ10 of the first silicon-based material is 3 μm to 10 μm, Dᵥ10 of the second silicon-based material is 1 μm to 4 μm, and the Dᵥ10 of the first silicon-based material is greater than the Dᵥ10 of the second silicon-based material, wherein Dᵥ10 refers to a particle size corresponding to a cumulative volume percentage of 10% in a volume-based particle size distribution starting from small particles.

2. The electrochemical device according to claim 1, wherein the Dᵥ10 of the first silicon-based material is 3 μm to 8 μm, and the Dᵥ10 of the second silicon-based material is 1 μm to 2 μm.

3. The electrochemical device according to claim 1, wherein based on a total mass of the first negative electrode active material layer, a mass percentage of the first silicon-based material in the first negative electrode active material layer is 5% to 20%;
based on a total mass of the second negative electrode active material layer, a mass percentage of the second silicon-based material in the second negative electrode active material layer is 10% to 40%; and
the mass percentage of the second silicon-based material in the second negative electrode active material layer is at least 5% greater than the mass percentage of the first silicon-based material in the first negative electrode active material layer.

4. The electrochemical device according to claim 3, wherein based on the total mass of the first negative electrode active material layer, the mass percentage of the first silicon-based material in the first negative electrode active material layer is 5% to 15%; and
based on the total mass of the second negative electrode active material layer, the mass percentage of the second silicon-based material in the second negative electrode active material layer is 10% to 30%.

5. The electrochemical device according to claim 1, wherein based on a total mass of the first negative electrode active material layer, a mass percentage of silicon element in the first negative electrode active material layer is 2% to 10%;
based on a total mass of the second negative electrode active material layer, a mass percentage of silicon element in the second negative electrode active material layer is 4% to 18%; and
the mass percentage of silicon element in the second negative electrode active material layer is at least 2% greater than the mass percentage of silicon element in the first negative electrode active material layer.

6. The electrochemical device according to claim 5, wherein based on the total mass of the first negative electrode active material layer, the mass percentage of silicon element in the first negative electrode active material layer is 2% to 6.6%; and
based on the total mass of the second negative electrode active material layer, the mass percentage of silicon element in the second negative electrode active material layer is 4% to 13.2%.

7. The electrochemical device according to claim 1, wherein the first negative electrode active material layer further comprises a first conductive agent, and the second negative electrode active material layer further comprises a second conductive agent;
based on a total mass of the first negative electrode active material layer, a mass percentage of the first conductive agent in the first negative electrode active material layer is 0.05% to 2%;
based on a total mass of the second negative electrode active material layer, a mass percentage of the second conductive agent in the second negative electrode active material layer is 0.2% to 1%; and
the mass percentage of the second conductive agent in the second negative electrode active material layer is greater than or equal to the mass percentage of the first conductive agent in the first negative electrode active material layer.

8. The electrochemical device according to claim 7, wherein based on the total mass of the second negative electrode active material layer, the mass percentage of the second conductive agent in the second negative electrode active material layer is 0.2% to 0.4%.

9. The electrochemical device according to claim 7, wherein the first silicon-based material and the second silicon-based material each independently comprise at least one of silicon oxide, silicon carbon, or pure silicon; and
the first conductive agent and the second conductive agent each independently comprise at least one of conductive carbon black, carbon nanotubes, metal particles, or carbon fibers.

10. An electronic device, comprising an electrochemical device, the electrochemical device comprising a negative electrode plate; wherein
the negative electrode plate comprises a negative electrode current collector, a first negative electrode active material layer, and a second negative electrode active material layer, and the first negative electrode active material layer is located between the negative electrode current collector and the second negative electrode active material layer; and
the first negative electrode active material layer comprises a first silicon-based material, the second negative electrode active material layer comprises a second silicon-based material, Dᵥ10 of the first silicon-based material is 3 μm to 10 μm, Dᵥ10 of the second silicon-based material is 1 μm to 4 μm, and the Dᵥ10 of the first silicon-based material is greater than the Dᵥ10 of the second silicon-based material, wherein Dᵥ10 refers to a particle size corresponding to a cumulative volume percentage of 10% in a volume-based particle size distribution starting from small particles.

11. The electronic device according to claim 10, wherein the Dᵥ10 of the first silicon-based material is 3 μm to 8 μm, and the Dᵥ10 of the second silicon-based material is 1 μm to 2 μm.

12. The electronic device according to claim 10, wherein based on a total mass of the first negative electrode active material layer, a mass percentage of the first silicon-based material in the first negative electrode active material layer is 5% to 20%;
based on a total mass of the second negative electrode active material layer, a mass percentage of the second silicon-based material in the second negative electrode active material layer is 10% to 40%; and
the mass percentage of the second silicon-based material in the second negative electrode active material layer is at least 5% greater than the mass percentage of the first silicon-based material in the first negative electrode active material layer.

13. The electronic device according to claim 12, wherein based on the total mass of the first negative electrode active material layer, the mass percentage of the first silicon-based material in the first negative electrode active material layer is 5% to 15%; and
based on the total mass of the second negative electrode active material layer, the mass percentage of the second silicon-based material in the second negative electrode active material layer is 10% to 30%.

14. The electronic device according to claim 10, wherein based on a total mass of the first negative electrode active material layer, a mass percentage of silicon element in the first negative electrode active material layer is 2% to 10%;
based on a total mass of the second negative electrode active material layer, a mass percentage of silicon element in the second negative electrode active material layer is 4% to 18%; and
the mass percentage of silicon element in the second negative electrode active material layer is at least 2% greater than the mass percentage of silicon element in the first negative electrode active material layer.

15. The electronic device according to claim 14, wherein based on the total mass of the first negative electrode active material layer, the mass percentage of silicon element in the first negative electrode active material layer is 2% to 6.6%; and
based on the total mass of the second negative electrode active material layer, the mass percentage of silicon element in the second negative electrode active material layer is 4% to 13.2%.

16. The electronic device according to claim 10, wherein the first negative electrode active material layer further comprises a first conductive agent, and the second negative electrode active material layer further comprises a second conductive agent;
based on a total mass of the first negative electrode active material layer, a mass percentage of the first conductive agent in the first negative electrode active material layer is 0.05% to 2%;
based on a total mass of the second negative electrode active material layer, a mass percentage of the second conductive agent in the second negative electrode active material layer is 0.2% to 1%; and
the mass percentage of the second conductive agent in the second negative electrode active material layer is greater than or equal to the mass percentage of the first conductive agent in the first negative electrode active material layer.

17. The electronic device according to claim 16, wherein based on the total mass of the second negative electrode active material layer, the mass percentage of the second conductive agent in the second negative electrode active material layer is 0.2% to 0.4%.

18. The electronic device according to claim 16, wherein the first silicon-based material and the second silicon-based material each independently comprise at least one of silicon oxide, silicon carbon, or pure silicon; and
the first conductive agent and the second conductive agent each independently comprise at least one of conductive carbon black, carbon nanotubes, metal particles, or carbon fibers.
